(19) United States
(12) Patent Application Publication
(10) Pub. No.: US 2005/0102845 A1
(43) Pub. Date: May 19, 2005

(54) Retention system for a hand tool combination

(75) Inventors: Edgar A. Dallas, Beaveron, OR (US); John A. Nason, Keizer, OR (US)

Correspondence Address: FOLEY & LARDNER, 777 EAST WISCONSIN AVENUE, SUITE 3800, MILWAUKEE, WI, 53202-5308, US

(73) Assignee: Alterra Holdings Corporation

(21) Appl. No.: 10/715,890

(22) Filed: Nov. 18, 2003

(51) Int. Cl. B26B 23/00

(52) U.S. Cl. 30/308.1; 81/22; 30/308

(57) ABSTRACT

A system for storing a first object in connection with a second object includes a first retainer having a first magnetic member coupled to the first object and a second retainer having a second magnetic member coupled to the second object. The second retainer is configured to coact with the first retainer so that the first retainer and the second retainer are operable to retain the second object in connection with the first object until the second object is removed by a user. A hand tool combination is also disclosed and includes a primary tool and a secondary tool and includes a first retainer coupled to the primary tool and a second retainer coupled to the secondary tool. The first retainer and the second retainer are configured for attraction by a magnetic force so that the secondary tool is retained in connection with the primary tool.

### FIELD

The present invention relates generally to the storage of one object within another object. The present invention relates more particularly to a first hand tool configured for storage of a second hand tool therein. The present invention relates more particularly to a retention system for retaining the second hand tool within the first hand tool as a combination unit.

### BACKGROUND

Combination hand tools that provide for storage of a second or secondary tool within a first or primary tool are generally known. For example, it is generally known to provide a primary hand tool such as an axe that is configured for storage of a secondary tool, such as a knife within a hollow portion of the handle of the axe. Such known hand tools typically are provided with a retention device, such as an end cap or a mechanical latch or catch, to retain the knife within the handle of the axe. The retention device should be configured for reliable operation in rugged environments that are typically encountered in activities common to hand tools such as axes or the like, and may include climbing, hiking, camping, working, hunting, fishing, etc. Further, the retention device should be readily operable by a user wearing protective gear, such as gloves or the like.

However, such known retention devices for use with combination hand tools tend to have certain drawbacks. For example, end caps for containing a secondary tool within a handle of the primary hand tool often tend to be dropped, misplaced or otherwise lost. Retainer cords for holding the end caps, such as tethers, tend to be inconvenient and create the risk of entanglement and other related nuisances or hazards. By further way of example, retention devices such as mechanical latches typically include springs, linkages, catches and/or release mechanisms, often with moving parts, that tend to wear out or break, or that are not suitable for reliable operation in rugged environments where contaminants (e.g. dirt, dust, water, etc.) tend to be present, or that are not conveniently operated by a user wearing gloves or the like.

Accordingly, it would be desirable to provide a retention system for a hand tool combination that is integrated into at least one of the hand tools of the combination. It would also be desirable to provide a retention system for a hand tool combination that is integrated into each of the hand tools. It would be further desirable to provide a retention system for a hand tool combination that is integrated into the tool(s) to minimize loss or misplacement. It would be further desirable to provide a retention system for a hand tool combination that resists entanglement with surrounding objects. It would be further desirable to provide a retention system for a hand tool combination that provides reliable use in rugged environments. It would be further desirable to provide a retention system for a hand tool combination that may be readily operated by a user wearing protective gear. It would be further desirable to provide a retention system for a hand tool combination that provides a force configured to retain a secondary hand tool within a primary hand tool. It would be further desirable to provide a retention system for a hand tool combination that provides a force configured to remove a secondary hand tool from a primary hand tool. It would be further desirable to provide a retention system for a hand tool combination that uses magnetic forces to retain and/or remove a second tool relative to a first tool.

Accordingly, it would be desirable to provide a retention system for a hand tool combination having any one or more of these or other advantageous features.

### SUMMARY

The present invention relates to a retention system for a hand tool combination having a primary tool and a secondary tool and includes a first retainer coupled to the primary tool and a second retainer coupled to the secondary tool. The first retainer and the second retainer are configured for attraction by a magnetic force so that the secondary tool is retained in connection with the primary tool.

The present invention also relates to a combination hand tool having a primary hand tool configured for storage of a secondary hand tool therein. The combination hand tool includes a receptacle formed within an elongated handle member of the primary hand tool. A first magnetic member is coupled to the primary hand tool and a second magnetic member is coupled to the secondary hand tool. The second magnetic member is configured to operably engage the first magnetic member so that the secondary hand tool is retained within the receptacle by a magnetic force.

The present invention further relates to a system for storing a first object in connection with a second object. The system includes a first retainer having a first magnetic member coupled to the first object and a second retainer having a second magnetic member coupled to the second object. The second retainer is configured to coact with the first retainer so that the first retainer and the second retainer are operable to retain the second object in connection with the first object until the second object is removed by a user.

The present invention further relates to an apparatus that includes a first hand tool having a receptacle and a second hand tool configured for storage within the receptacle. A retention system having a first retainer is coupled to the first hand tool and a second retainer is coupled to the second hand tool. The first retainer and the second retainer are configured for magnetic attraction so that the second hand tool is retained within the receptacle until removed by a user.

### BRIEF DESCRIPTION OF THE DRAWINGS

FIG. 1 is a schematic representation of a perspective view of a hand tool combination according to one embodiment.

FIG. 2 is a schematic representation of an exploded perspective view of a hand tool combination according to one embodiment.

FIG. 3A is a schematic representation of a cross sectional view of a retention system shown with a portion of the hand tool combination of FIG. 1 according to one embodiment.

FIG. 3B is a schematic representation of another cross sectional view of the retention system shown in FIG. 3A.

FIG. 3C is a schematic representation of another cross sectional view of the retention system shown in FIG. 3A.

FIG. 4A is a schematic representation of a cross sectional view of a retention system shown with a portion of the hand tool combination of FIG. 1 according to another embodiment.

FIG. 4B is a schematic representation of another cross sectional view of the retention system shown in FIG. 4A.

### DETAILED DESCRIPTION

Referring to the FIGURES, a retention system for storing one object in connection with another object, such as a hand tool combination 10 including a primary hand tool 20 and a secondary hand tool 30, is shown schematically according to an exemplary embodiment. Secondary hand tool 30 is configured for storage in connection with primary hand tool 20. The hand tool combination 10 is shown and described according to an exemplary embodiment as an axe (for the primary hand tool) and as a knife (for the secondary hand tool). However, the retention system for a hand tool combination shown and described herein is suitable for use with a wide variety of hand tool combinations. For example, the primary hand tool may be any object or tool having a suitable receptacle for accommodating storage of the secondary hand tool. Such primary hand tools may be, for example, tools with elongated handles (e.g. hammers, shovels, camping equipment, garden equipment, hiking equipment, etc.). Such secondary hand tools may be, for example, any object or tool useful in activities related to the primary hand tool and sized for storage in connection with the receptacle of the primary hand tool (e.g. saws, cooking utensils, survival gear items, camping gear items, fishing gear items, storage capsules, etc.). According to any preferred embodiment, the retention system is configured to securely retain the secondary hand tool in connection with the primary hand tool, and to permit a user to readily access the secondary hand tool for use independent from (or in connection with) the primary hand tool.

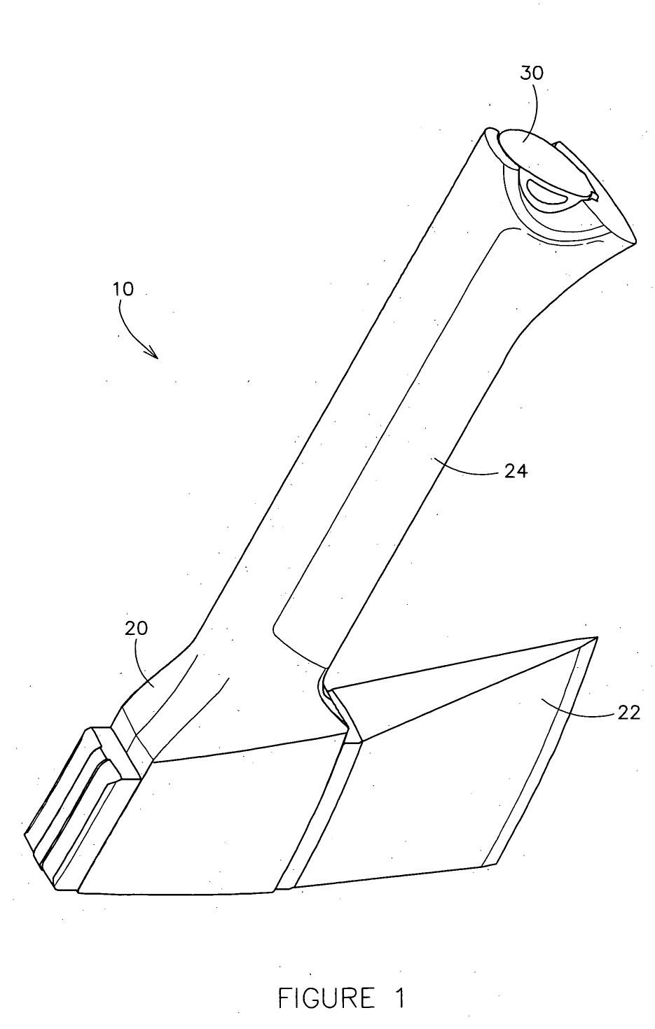

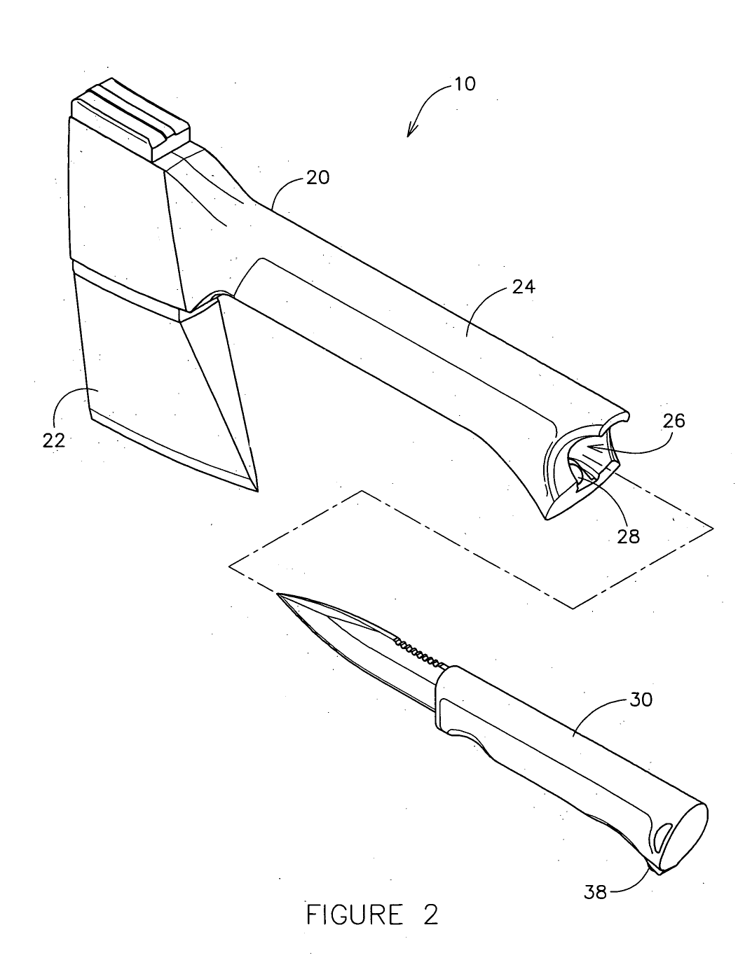

Referring to FIGS. 1, 2 and 3A-3C, a retention system 12 is shown for use with primary hand tool 20 and secondary hand tool 30 according to one embodiment. Primary hand tool 20 is shown schematically to include a tool head 22 coupled to an elongated handle member 24 which may be formed from a non-metallic material. A receptacle 26 (e.g. hollow, cavity, compartment, pocket, recess, etc.) is provided in primary hand tool 20 for storage of secondary hand tool 30. Receptacle 26 is shown as a hollow portion of elongated handle member 24 that is configured to receive secondary hand tool 30 therein for storage.

Retention system 12 is configured to retain secondary hand tool 30 in position within receptacle 26 of primary hand tool 20. Retention system 12 is shown to include a first retainer 28 coupled to primary hand tool 20, and a second retainer 38 coupled to secondary hand tool 30, configured to coact in a manner intended retain secondary hand tool 30 within receptacle 26 to positively “hold” secondary hand tool 36 in place.

According to one preferred embodiment, first retainer 28 and second retainer 38 are magnetic members (e.g. magnets, rare earth magnets, etc.) having opposing magnetic poles (e.g. a “north” pole and a “south” pole, or a “positive” pole and a “negative” pole). First retainer 28 and second retainer 38 are located to generally correspond or align with each other when secondary hand tool 30 is stowed in receptacle 26 of primary hand tool 20. The magnetic poles of first retainer 28 and second retainer 38 are configured to be “opposing” to create a magnetic attraction force when secondary hand tool 30 is stowed in receptacle 26 (e.g. the “north” pole of the first retainer communicates with the “south” pole of the second retainer, or the “south” pole of the first retainer communicates with the “north” pole of the second retainer, etc.). The magnetic members may have any suitable shape (e.g. circular, rectangular, etc.) and may be coupled to the primary hand tool and the secondary hand tool in any suitable manner such as by snap fit, interference fit, adhesive bonded, molded in place, etc.

First retainer 28 is shown fixed at a location on primary hand tool 20 (shown schematically as adjacent an inside end of elongated handle member 24), and second retainer 38 is shown fixed at a location on secondary hand tool 30 (shown schematically as adjacent an outside end of the secondary hand tool 30), so that the first and second retainers are relatively “concealed” when secondary hand tool 30 is stowed in receptacle 26. The alignment of the first and second retainers is intended to create a magnetic attraction force between first retainer 28 and second retainer 38 when secondary hand tool 30 is stowed in receptacle 26 and the first and second retainers come into proximity. The magnetic attraction force is configured to “draw” or “pull” secondary hand tool 30 and receptacle 26 into a positively stowed position. The location of first retainer 28 relative to second retainer 38 may also be provided with an “offset” (e.g. not completely aligned with each other) when in the stowed position so that the amount of magnetic attraction force created between the first and second retainers can be adjusted or tailored to suit a particular application.

The size and/or strength of the magnetic members are selected to provide a relatively secure retention of secondary hand tool 30 within receptacle 26 during normal usage conditions associated with primary hand tool 20, yet still permit secondary hand tool 30 to be removed when a user pulls against the magnetic attraction using a reasonable amount of force to separate the first and second retainers. According to a particularly preferred embodiment where the first hand tool is an axe and the second hand tool is a knife, the magnetic members are rare earth magnets having a minimum magnetic field strength of approximately 4000 gauss (or corresponding generally to approximately a three and one-half (3½) pound pull). However, other types of magnets having varying strengths may be used to provided the desired retention for any particular combination of hand tools.

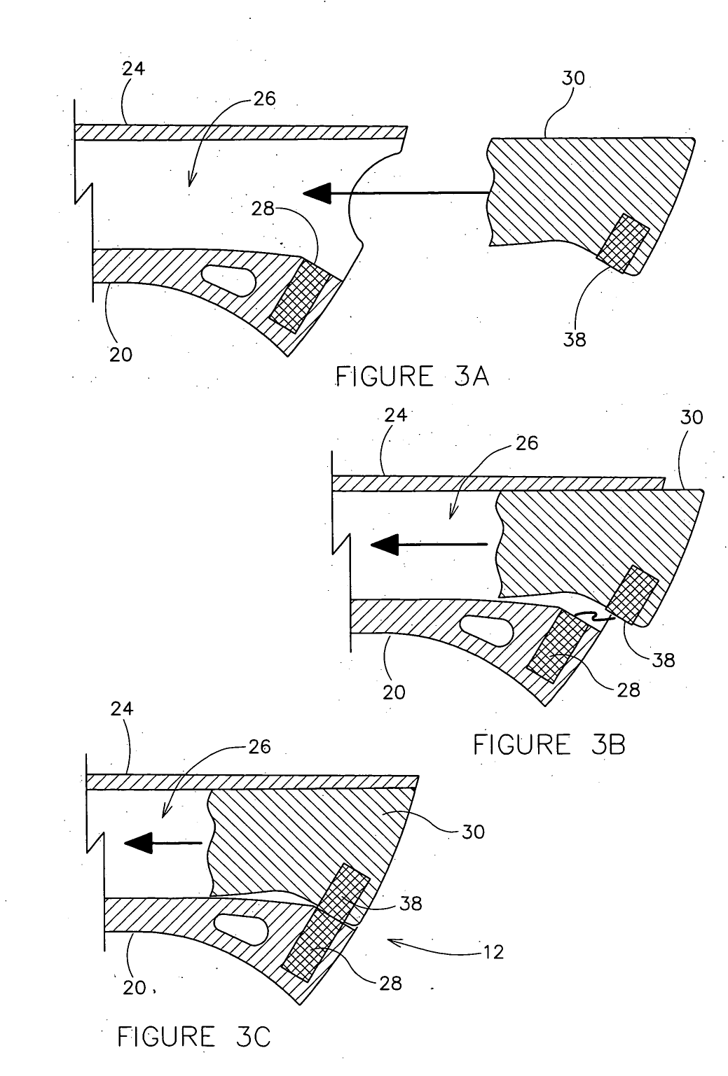

According to any preferred embodiment, the retention system of the present embodiment shown in FIGS. 3A-3C is intended to positively retain the secondary tool in connection with the receptacle. The retention system is intended to avoid the use of removable caps, tethers, springs, linkages and other loose or moving parts. The force created by the magnetic members may be adjusted to suit a particular application by selecting an appropriate magnet type having a desired magnetic field strength, and/or by positioning the magnets to have a certain relative offset (e.g. gap, misalignment, etc.). The retention system is intended to be operable by a user wearing protective gear (e.g. gloves, etc.) and is intended to resist degradation due to exposure to environmental contaminants.

According to an alternative embodiment, one of the retainers may be replaced with a metallic material responsive to magnetic attraction (e.g. steel, iron or other ferrous material, etc.) for applications where the attraction force of a single magnet is sufficient to retain the secondary hand tool. According to another alternative embodiment, the retainers may be located at any suitable position on the primary and/or secondary hand tools to create a desirable retention force for the secondary hand tool.

Referring to FIGS. 1, 2 and 4A-4B, a retention system 42 is shown for use with primary hand tool 20 and secondary hand tool 30 according to another embodiment. Retention system 42 includes a first retainer 46 (e.g. “actuatable” retainer) coupled to primary hand tool 20 and a second retainer 48 (e.g. “fixed”retainer) coupled to secondary hand tool 30. Second retainer 48 is similar to second retainer 38 previously described for the embodiment shown in FIGS. 3A-3B and is shown having a “fixed” polarity. First retainer 46 includes an actuatable member (shown schematically as a rotatable thumbwheel 44) disposed adjacent to receptacle 26 for magnetic communication with second retainer 48 on secondary hand tool 30. Thumbwheel 44 includes a magnetic member extending through the body of the thumbwheel so that opposing poles (e.g. a “north” pole and a “south” pole, or a “positive” pole and a “negative” pole) of the magnetic member are positioned on opposing sides of thumbwheel 44. The polarity of first retainer 46 can be “alternated” by rotating thumbwheel 44 so that either pole is aligned for communication with the “fixed” pole of second retainer 48.

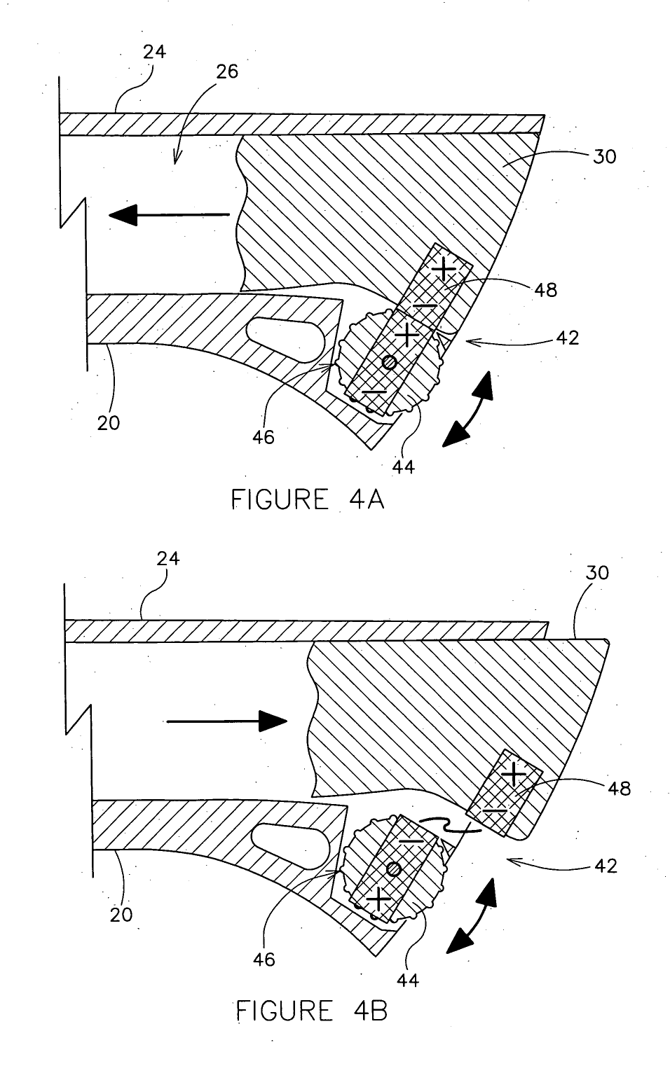

When a user inserts secondary hand tool 30 into receptacle 26, the magnetic attraction forces between the approaching magnetic members tend to rotate thumbwheel 44 so that the “opposing” pole on first retainer 46 aligns with the “fixed” pole on second retainer 48 to attract or otherwise “draw” secondary hand tool 30 into receptacle 26 and provide a positive retention force to “hold” secondary hand tool 30 in position within receptacle 26 (as shown schematically in FIG. 4A).

The first retainer 46 may be actuated to provide a “repelling” magnetic force to assist in extracting-(e.g. removing, withdrawing, etc.) secondary hand tool 30 from the receptacle 26. Thumbwheel 44 may be manually rotated by a user so that the polarity of first retainer 46 “matches” the fixed polarity of second retainer 48 so that a magnetic repelling force is created that tends to “push” secondary hand tool 30 from receptacle 26 to assist a user in accessing the secondary hand tool (as shown schematically in FIG. 4B).

According to any preferred embodiment, the retention system shown schematically in FIGS. 4A-4B is configured to provide a retention system that is actuatable between a retention mode where the secondary hand tool is magnetically biased for retention within the receptacle and an extraction mode where the secondary hand tool is magnetically biased for extraction from the receptacle.

According to an alternative embodiment, the orientation of the first and second receptacles may be reversed so that the actuatable member is coupled to the secondary hand tool. According to another alternative embodiment, the actuatable member may configured for other forms of motion (e.g. pivotal, translational, etc.).

It is important to note that the construction and arrangement of the elements of the retention system for a hand tool combination provided herein are illustrative only. Although only a few exemplary embodiments of the present invention(s) have been described in detail in this disclosure, those skilled in the art who review this disclosure will readily appreciate that many modifications are possible in these embodiments (such as variations in features such as strength of the magnetic members, orientation of magnetic polarity, and relative positioning or alignment of the retainers; variations in sizes, structures, shapes, dimensions and proportions of the components of the system, use of materials, colors, combinations of shapes, method and manner of coupling the magnetic members to the tools, etc.) without materially departing from the novel teachings and advantages of the invention(s). For example, the primary had tool may be any suitable hand tool having a suitable receptacle for receiving a secondary hand tool for storage, and the secondary hand tool may be any suitable tool, device or object for use by a user. Such secondary tools may include compartments, capsules, containers or the like for storing other objects (e.g. fishing gear, camping gear, survival gear, first-aid materials, informational materials such as maps, instructions, etc.) that may be useful in connection with activities related to the primary tool. According to other alternative embodiments, the retention system for a hand tool combination may position the retainers in various alternate configurations suitable to provide the desired retention properties for a particular application. Further, it is readily apparent that variations of the retention system for a hand tool combination and its components and elements may be provided in a wide variety of types, shapes, sizes and retention and/or extraction forces, or provided in locations internal, external or partially external to the hand tool combination. Accordingly, all such modifications are intended to be within the scope of the invention(s).

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as-expressed in the appended claims.

1. A retention system for a hand tool combination having a primary tool and a secondary tool, comprising:
a first retainer coupled to the primary tool;
a second retainer coupled to the secondary tool;
wherein the first retainer and the second retainer are configured for attraction by a magnetic force;
so that the secondary tool is retained in connection with the primary tool.

2. The retention system of claim 1 wherein the first retainer comprises a first magnetic member fixed to the primary tool.

3. The retention system of claim 2 wherein the second retainer comprises a second magnetic member fixed to the secondary tool.

4. The retention system of claim 3 wherein the first magnetic member has a first polarity and the second magnetic member has a second polarity opposite from the first polarity.

5. The retention system of claim 1 wherein the first retainer is substantially aligned with the second retainer when the secondary tool is retained in the receptacle.

6. The retention system of claim 1 wherein the primary tool is an axe.

7. The retention system of claim 6 wherein the secondary tool is one of a knife and a saw.

8. The retention system of claim 1 wherein the first retainer comprises a magnetic material and the second retainer comprises a metallic material responsive to magnetic attraction.

9. The retention system of claim 1 wherein the first retainer comprises a metallic material responsive to magnetic attraction and the second retainer comprises a magnetic material.

10. A combination hand tool having a primary hand tool configured for storage of a secondary hand tool therein, the combination hand tool comprising:
a receptacle formed within an elongated handle member of the primary hand tool;
a first magnetic member coupled to the primary hand tool;
a second magnetic member coupled to the secondary hand tool and configured to operably engage the first magnetic member;
so that the secondary hand tool is retained within the receptacle by a magnetic force.

11. The combination hand tool of claim 10 wherein the primary hand tool is an axe and the secondary hand tool is one a camping gear item, a survival gear item a fishing gear item, a hiking gear item, and a fishing gear item.

12. The combination hand tool of claim 10 wherein the first magnetic member is coupled to an actuatable member configured to alternate a polarity of the first magnetic member for interfacing with the second magnetic member.

13. The combination hand tool of claim 12 wherein the actuatable member is a thumbwheel.

14. The combination hand tool of claim 10 wherein the first magnetic member and the second magnetic member are operable to at least partially withdraw the second hand tool from the receptacle.

15. The combination hand tool of claim 10 wherein the magnetic force is a minimum of approximately 4000 gauss.

16. The combination hand tool of claim 10 wherein the first magnetic member is fixed to the primary hand tool and the second magnetic member is fixed to the secondary hand tool.

17. The combination hand tool of claim 10 wherein the first magnetic member and the second magnetic member are configured in substantial alignment when the secondary hand tool is retained within the primary hand tool.

18. The combination hand tool of claim 10 wherein the first magnetic member and the second magnetic member are configured in at least a partially offset relationship when the secondary hand tool is retained within the primary hand tool.

19. The combination hand tool of claim 12 wherein the actuatable member is configured for rotational movement.

20. A system for storing a first object in connection with a second object, comprising:
a first retainer having a first magnetic member coupled to the first object;
a second retainer having a second magnetic member coupled to the second object and configured to coact with the first retainer;
so that the first retainer and the second retainer are operable to retain the second object in connection with the first object until the second object is removed by a user.

21. The system of claim 20 wherein the first object is a hand tool.

22. The system of claim 20 wherein the first retainer is configured to be actuatable between a first position for retention of the second object and a second position for extraction of the second object.

23. The system of claim 22 wherein the first magnetic member and the second magnetic member are attracted in the first position.

24. The system of claim 23 wherein the first magnetic member and the second magnetic member are repelled in the second position.

25. The system of claim 20 wherein the first magnetic member is fixed to the first object and the second magnetic member is fixed to the second object.

26. The system of claim 20 wherein the first object comprises an elongated member providing a receptacle and the second object is configured for retention within the receptacle.

27. The system of claim 26 wherein the first object is a camp axe and the second object is one of a knife, a saw, a cooking utensil, a compartment, a camping gear item, a hunting gear item, a fishing gear item and a survival gear item.

28. In an apparatus comprising a first hand tool having a receptacle and a second hand tool configured for storage within the receptacle, the improvement comprising a retention system having a first retainer coupled to the first hand tool and a second retainer coupled to the second hand tool, where the first retainer and the second retainer are configured for magnetic attraction, so that the second hand tool is retained within the receptacle until removed by a user.

29. The apparatus of claim 28 wherein the first hand tool comprises a first cutting tool and the second hand tool comprises a second cutting tool.

30. The apparatus of claim 28 wherein the first retainer comprises a first magnetic member.

31. The apparatus of claim 30 wherein the first retainer is configured to alternate the polarity of the first magnetic member relative to the second retainer.

32. The apparatus of claim 31 wherein the first magnetic member is configured for rotation.

33. The apparatus of claim 28 wherein the second retainer comprises a second magnetic member.

34. The apparatus of claim 28 wherein the first retainer is actuatable between a first position for retention of the second hand tool within the receptacle and a second position for withdrawal of the second hand tool from the receptacle.
